(19) United States
(12) Patent Application Publication
(10) Pub. No.: US 2025/0189319 A1
(43) Pub. Date: Jun. 12, 2025

(54) NAVIGATION METHOD AND SYSTEM BASED ON TERRAIN FEATURE

(71) Applicant: HYUNDAI AUTOEVER CORP., Seoul (KR)

(72) Inventor: Young Hurck Cha, Seoul (KR)

(73) Assignee: HYUNDAI AUTOEVER CORP., Seoul (KR)

(21) Appl. No.: 18/958,895

(22) Filed: Nov. 25, 2024

(30) Foreign Application Priority Data
Dec. 11, 2023 (KR) 10-2023-0178452

(51) Int. Cl. G01C 21/30; G06V 20/58

(52) U.S. Cl. CPC G01C 21/30; G06V 20/58

(57) ABSTRACT

There is provided a navigation method performed by a computing system. The method may comprise acquiring an image of a surrounding located in front of a vehicle using a sensing device, determining a target object acting as a terrain feature among a plurality of objects included in the acquired image of the surrounding located in front of the vehicle, determining a movement direction in which a driver drives along a driving route at a position of the target object and outputting navigation information including the determined target object and movement direction.

### CROSS-REFERENCE TO RELATED APPLICATION

This application claims priority to Korean Patent Application No. 10-2023-0178452, filed on Dec. 11, 2023 in the Korean Intellectual Property Office, the contents of which in its entirety are incorporated herein by reference.

### BACKGROUND

### Field

The present disclosure relates to a navigation method and system. More specifically, the present disclosure relates to a method and system for performing navigation based on a terrain feature on a road.

### Description of Related Art

A navigation device is mounted on a vehicle, etc., and guides a driver along a driving route to a destination. Furthermore, the navigation device displays a driving route using a line having a predetermined color. For example, the navigation device determines a color of a line indicating a driving route based on a congestion level of each road.

Furthermore, when a vehicle needs to turn, the navigation device outputs information guiding the vehicle to turn before reaching a turn point. However, in a complex road section, a driver may not properly recognize the vehicle turn point and thus enter an incorrect route.

The statements in this Background section merely provide background information related to the present disclosure and may not constitute prior art.

### SUMMARY

A technical purpose to be achieved in accordance with some embodiments of the present disclosure is to provide a navigation method and system that provides an intuitive and precise driving route based on a terrain feature located ahead of a vehicle on an actual driving road.

Another technical purpose to be achieved in accordance with some embodiments of the present disclosure is to provide a navigation method and system of determining a terrain feature that may be easily recognized by a driver with the naked eye from among terrain features recognized and positioned ahead of a vehicle, designating it as a target object, and performing intuitive navigation based on the target object.

Still another technical purpose to be achieved in accordance with some embodiments of the present disclosure is to provide a navigation method and system of providing navigation information so that the driver may easily enter a correct route before a vehicle turns.

The technical purposes of the present disclosure are not limited to the technical purposes as mentioned above, and other technical purposes as not mentioned may be clearly understood by those skilled in the art from descriptions as set forth below.

According to an aspect of the present disclosure, there is provided a navigation method performed by a computing system. The method may comprise: acquiring an image of a surrounding located in front of a vehicle using a sensing device, determining a target object acting as a terrain feature among a plurality of objects included in the acquired image of the surrounding located in front of the vehicle, determining a movement direction in which a driver drives along a driving route at a position of the target object and outputting navigation information including the determined target object and movement direction.

In some embodiments, the acquiring of the image of the surrounding located in front of the vehicle may include: measuring a position of the vehicle, calculating a residual distance to a turning point based on the driving route and the measured position of the vehicle and when the calculated residual distance is smaller than or equal to a predetermined threshold distance, acquiring the image of the surrounding located in front of the vehicle using the sensing device.

In some embodiments, the acquiring of the image of the surrounding located in front of the vehicle may include: measuring a position and a speed of the vehicle, calculating a remaining time until reaching a turning point based on the driving route, the measured position and speed of the vehicle and when the calculated remaining time is smaller than or equal to a predetermined threshold time, acquiring the image of the surrounding located in front of the vehicle using the sensing device.

In some embodiments, the determining of the target object may include: recognizing the plurality of objects included in the image of the surrounding located in front of the vehicle, determining of the points of each of the recognized plurality of objects based on a type of each of the recognized plurality of objects and determining the target object among the plurality of objects, based on the determined points of each of the plurality of objects.

In some embodiments, the determining of the points of each of the plurality of objects may include: identifying a specific time range including a current time among a predetermined plurality of time ranges and determining the points of each of the plurality of objects, based on object type-specific points data related to the identified specific time range.

In some embodiments, the determining of the points of each of the plurality of objects may include: assigning first points to each of the plurality of objects with reference to first points data in which points of each object type is recorded, assigning second points to each of the plurality of objects with reference to second points data in which points of each object type is recorded, wherein the second points data are different from the first points data and determining the points of each of the plurality of objects, based on the first points and the second points assigned to each of the plurality of objects.

In some embodiments, the determining of the points of each of the plurality of objects may include: applying a first weight to the first points, applying a second weight to the second points, summing the first points to which the first weight has been applied and the second points to which the second weight has been applied and determining the points of each object, based on the summing result.

In some embodiments, the determining of the target object may include: determining coordinates on a map where the target object is located, wherein the determining of the movement direction may include determining a turn angle at which the driver can drive along the driving route at the determined coordinates as the movement direction.

In some embodiments, the determining of the target object may include: determining an auxiliary object located between the target object and the vehicle, from among the plurality of objects included in the acquired image of the surrounding located in front of the vehicle, wherein the navigation information may further include the auxiliary object, wherein the navigation information guides a driver to pass by the auxiliary object, and then, drive in the movement direction at the target object.

According to another aspect of the present disclosure, there is provided a navigation method performed by a computing system. The method may comprise: acquiring an image of a surrounding located in front of a vehicle using a sensing device, transmitting the image of the surrounding located in front of the vehicle to an external device, receiving precise driving route data generated based on the image of the surrounding located in front of the vehicle from the external device and outputting navigation information for guiding a driver to drive in a movement direction at an object acting as a terrain feature, based on the precise driving route data.

In some embodiments, the acquiring of the image of the surrounding located in front of the vehicle using the sensing device may include: determining whether a precise navigation-related event has occurred and upon determination that the precise navigation related event has occurred, acquiring the image of the surrounding located in front of the vehicle using the sensing device.

In some embodiments, the determining of whether the precise navigation-related event has occurred may include: measuring a position of the vehicle, calculating a remaining distance to a turning point, based on the driving route and the measured position of the vehicle and when the calculated remaining distance is smaller than or equal to a predetermined threshold distance, determining that the precise navigation-related event has occurred.

In some embodiments, the determining of whether the precise navigation-related event has occurred may include: measuring a position and a speed of the vehicle, calculating a remaining time until reaching a turning point, based on the driving route, the measured position and speed of the vehicle and when the calculated remaining time is smaller than or equal to a predetermined threshold time, determining that the precise navigation-related event has occurred.

In some embodiments, the acquiring of the image of the surrounding located in front of the vehicle may include: measuring a position of the vehicle, calculating a remaining distance to a turning point, based on the driving route of the vehicle and the measured position of the vehicle and when the calculated remaining distance is smaller than or equal to a predetermined threshold distance, acquiring the image of the surrounding located in front of the vehicle, using the sensing device.

In some embodiments, the acquiring of the image of the surrounding located in front of the vehicle may include: measuring a position and a speed of the vehicle, calculating a remaining time until reaching a turning point, based on the driving route of the vehicle and the measured position and speed of the vehicle and when the calculated remaining time is smaller than or equal to a predetermined threshold time, acquiring the image of the surrounding located in front of the vehicle, using the sensing device.

According to another aspect of the present disclosure, a system may comprise one or more processors; and a memory that loads a computer program executed by the processor, wherein the computer program may comprises instructions for performing operations comprising: receiving an image of a surrounding located in front of the vehicle from a communication terminal, determining a target object acting as a terrain feature from among a plurality of objects included in the received image of the surrounding located in front of the vehicle, determining a movement direction in which the driver can drive along a driving route at a location of the target object and transmitting precise driving route data including data related to the determined target object and the determined movement direction to the communication terminal.

### BRIEF DESCRIPTION OF DRAWINGS

The above and other aspects and features of the present disclosure should become more apparent by describing in detail illustrative embodiments thereof with reference to the attached drawings, in which:

FIG. 1 is a schematic diagram illustrating that precise navigation information is outputted through a navigation device included in a vehicle according to an embodiment of the present disclosure;

FIG. 2 is a diagram illustrating a configuration of a navigation service system according to an embodiment of the present disclosure;

FIG. 3 is a flowchart illustrating a method for performing navigation based on a terrain feature according to an embodiment of the present disclosure;

FIG. 4 is a flowchart illustrating operation in S110 of FIG. 3 in more detail according to an embodiment of the present disclosure;

FIG. 5 is a flowchart illustrating operation in S120 of FIG. 3 in more detail according to an embodiment of the present disclosure;

FIG. 6 is a diagram illustrating an example of points data of an object based an object type according to an embodiment of the present disclosure;

FIG. 7 is a diagram illustrating an example of navigation information according to an embodiment of the present disclosure;

FIG. 8 is a diagram illustrating another example of navigation information according to an embodiment of the present disclosure;

FIG. 9 is a signal processing diagram performing a navigation method based on a terrain feature according to another embodiment of the present disclosure;

FIG. 10 is a flowchart illustrating a method for performing navigation based on a terrain feature according to still another embodiment of the present disclosure;

FIG. 11 is a flowchart illustrating a method for performing navigation based on a terrain feature according to still yet another embodiment of the present disclosure.

FIG. 12 is a hardware configuration diagram of a computing system according to some embodiments of the present disclosure.

### DETAILED DESCRIPTIONS

Hereinafter, embodiments of the present disclosure are described with reference to the attached drawings. Advantages and features of the present disclosure and methods of accomplishing the same may be understood more readily by reference to the following detailed description of the embodiments and the accompanying drawings. The present disclosure may, however, be embodied in many different forms and should not be construed as being limited to the embodiments set forth herein. Rather, these embodiments are provided so that this disclosure should be thorough and complete and will fully convey the concept of the disclosure to those having ordinary skill in the art.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof is omitted.

Unless otherwise defined, all terms used in the present specification (including technical and scientific terms) may be used in a sense that can be commonly understood by those having ordinary skill in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

When a component, device, element, or the like of the present disclosure is described as having a purpose or performing an operation, function, or the like, the component, device, or element should be considered herein as being “configured to” meet that purpose or to perform that operation or function.

In the embodiments of the present disclosure, the term ‘graphic element’ may be graphic-based data including at least one of a shape, a color, or text. For example, a specific graphic element may be a specific shape, a specific color, or a specific text.

In the embodiments of the present disclosure, the term ‘terrain feature’ may include man-made signs, traffic lights, tunnels, roads, crosswalks, bridges, intersections, buildings, etc. Furthermore, the terrain feature may include naturally occurring rocks, cliffs, valleys, rivers, etc.

Hereinafter, some embodiments of the present disclosure are described in detail with reference to the attached drawings.

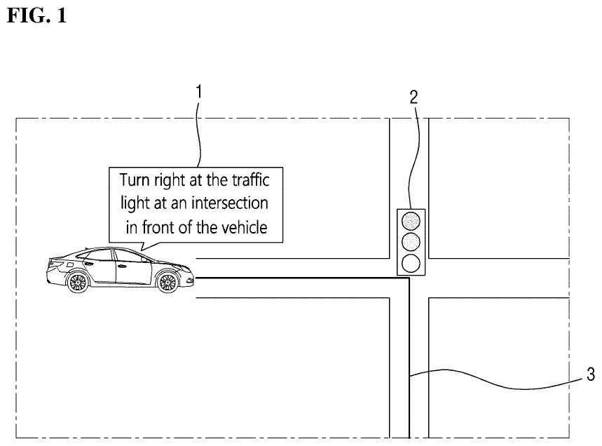

FIG. 1 is a schematic diagram for illustrating that navigation information is outputted through a navigation device included in a vehicle according to one embodiment of the present disclosure.

Referring to FIG. 1, the vehicle having the navigation device and sensors may acquire an image of a surrounding located in front of the vehicle, and may recognize a plurality of objects based on the image of the surrounding located in front of the vehicle. Each object may be an object related to a road terrain feature. Among the recognized objects, a specific object may be determined as a target object 2. In this regard, the target object may be a terrain feature that a driver may most easily recognize near a turn point among the plurality of objects. In FIG. 1, an example in which a traffic light is determined as the target object 2 is shown.

When the target object has been determined, navigation information 1 for guiding the driver to drive along a driving route 3 based on the target object 2 may be output. The navigation information 1 may be output on a screen of the navigation device 10 in text form or may be output in voice form through a speaker.

As illustrated in FIG. 1, in order to drive along the driving route 3, the navigation information 1 such as “Turn right at the traffic light at an intersection in front of the vehicle” may be output. Through this navigation information 1, the driver may intuitively recognize the need to turn right based on the traffic light. Accordingly, navigation information that may be easily identified may be provided to the driver who cannot accurately identify the map provided by the navigation system, thereby preventing the driver from entering an incorrect route, and allowing the vehicle to drive along the intended driving route.

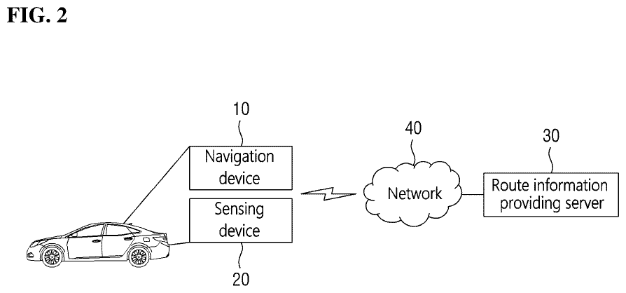

FIG. 2 is a diagram for illustrating a configuration of a navigation service system according to an embodiment of the present disclosure.

Referring to FIG. 2, the navigation service system according to an embodiment of the present disclosure may include a navigation device 10, a sensing device 20, and a route information providing server 30.

The route information providing server 30 may communicate with each of the navigation device 10 and the sensing device 20 through a network 40. In this regard, the network 40 may be configured to include a mobile communication network, a wired communication network, a short-range wireless communication network, etc.

According to one embodiment, the navigation device 10 may be mounted on a vehicle. According to some embodiments, the navigation device 10 may be included in a mobile terminal.

The sensing device 20 may acquire the image of the surrounding located in front of the vehicle. In order to acquire the image of the surrounding located in front of the vehicle, the sensing device 20 may include a lidar sensor, an image capturing device, etc. According to some embodiments, the sensing device 20 may acquire the image of the surrounding located in front of the vehicle through control of the navigation device 10.

The navigation device 10 includes a GNSS (Global Navigation Satellite System) receiver, and may measure a current location using the GNSS receiver. The navigation device 10 may transmit the current location and a destination location to the route information providing server 30 and may receive a driving route to the destination therefrom. The navigation device 10 may perform navigation based on the received driving route.

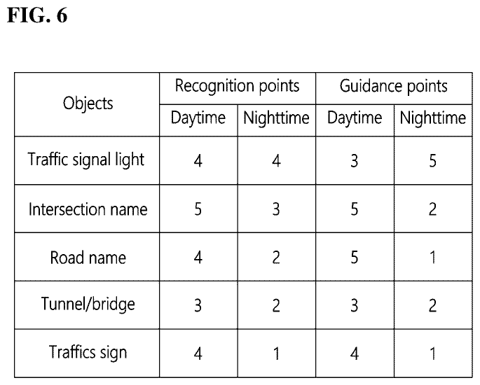

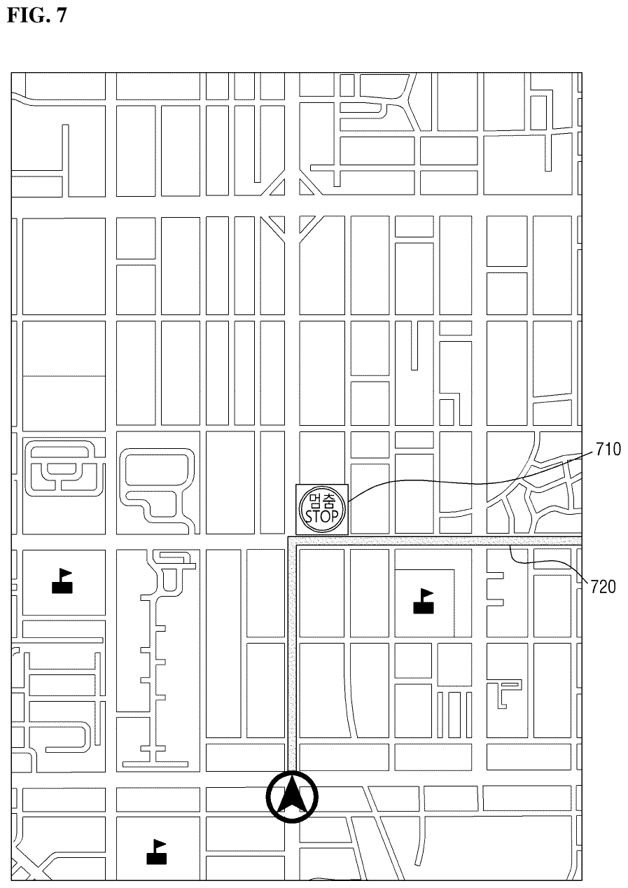

According to one embodiment, the navigation device 10 determines whether a precise navigation related event has occurred. When the precise navigation related event has occurred, the navigation device 10 may acquire the image of the surrounding located in front of the vehicle using the sensing device. According to one embodiment, the navigation device 10 recognizes a plurality of objects included in the acquired image of the surrounding located in front of the vehicle, and may determine a target object, among the recognized plurality of objects, based on the precise navigation. A specific method for determining the target object among the plurality of objects is described with reference to FIG. 6 and FIG. 7.

Furthermore, the navigation device 10 may determine a movement direction in which the driver can drive along the driving route at a location of the target object, and may output navigation information including the determined target object and movement direction. In this regard, the navigation information may be information that guides the user to drive in the movement direction at the target object.

According to some embodiments, the navigation device 10 may transmit the image of the surrounding located in front of the vehicle, as acquired using the sensing device, to the route information providing server 30. The navigation device 10 may receive precise driving route data including the target object and the movement direction in response thereto from the route information providing server 30. In this case, the navigation device 10 may output the navigation information that guides the driver in the movement direction at the location of the target object based on the precise driving route data.

The route information providing server 30 may receive a route search request including the vehicle location and the destination location from the navigation device 10. In this case, the route information providing server 30 may search for one or more routes based on a congestion level of each road section, the vehicle location, the destination location, etc., and transmit the searched at least one route to the navigation device 10. In this regard, the one or more routes may include the shortest route, the smallest time route, etc.

According to some embodiments, the route information providing server 30 may receive the image of the surrounding located in front of the vehicle from the navigation device 10, and may determine the target object from the plurality of objects included in the received image of the surrounding located in front of the vehicle. Furthermore, the route information providing server 30 may determine the movement direction in which the driver can drive along the driving route at the location of the target object, and may transmit the precise driving route data including data related to the determined target object and the movement direction to the navigation device 10. In this regard, the data related to the target object may include an identifier of the target object and coordinates of the target object. According to one embodiment, the route information providing server 30 may store therein map data including each terrain feature's coordinates, and may identify coordinates where the target object is located based on the terrain feature coordinates included in the map data.

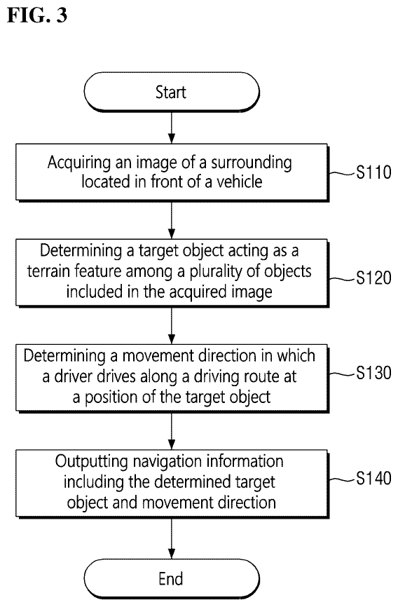

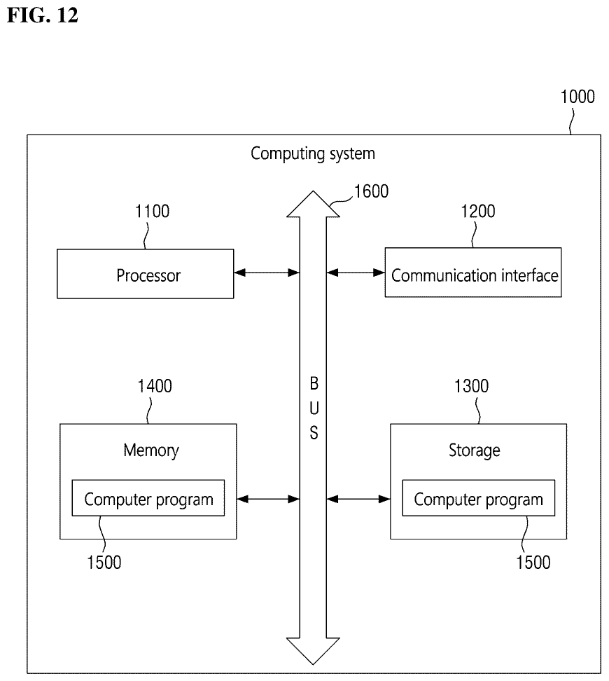

FIG. 3 is a flow chart for illustrating a method for performing navigation based on a terrain feature according to an embodiment of the present disclosure. The method illustrated in FIG. 3 is only an embodiment for achieving the purpose of the present disclosure, and some operations may be added or deleted as needed. Furthermore, the method illustrated in FIG. 3 may be performed by at least one processor (e.g., a processor illustrated in FIG. 12) included in the computing system. In this regard, the computing system may include at least one of the navigation device, the mobile terminal, and the route information providing server. The method illustrated in FIG. 3 will be described under assumption that the method is performed by the navigation device illustrated in FIG. 1.

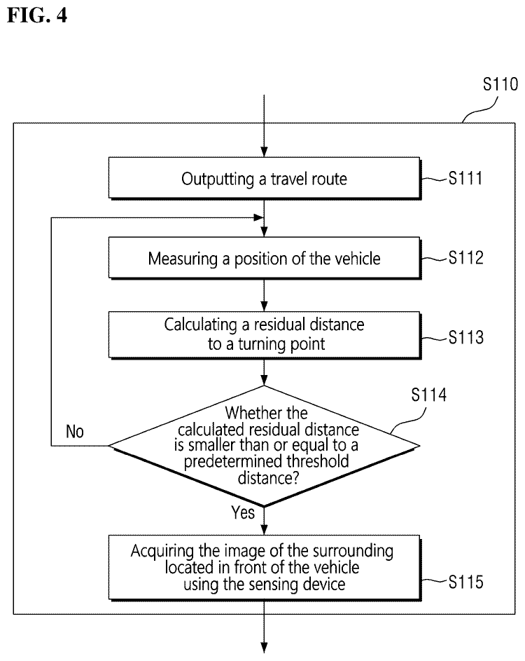

Referring to FIG. 3, the navigation device may acquire the image of the surrounding located in front of the vehicle using the sensing device in a step S110. According to one embodiment, the navigation device may acquire the image of the surrounding located in front of the vehicle by using the sensing device at the time when an event related to precise navigation has occurred. Operations in the S110 are described in detail with reference to FIG. 4.

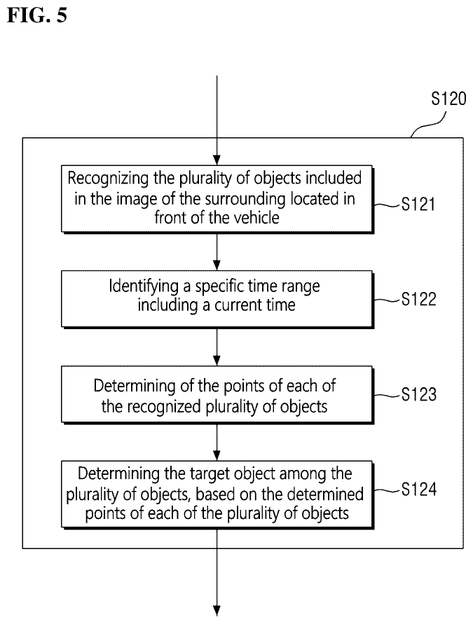

Next, the navigation device may determine the target object from among the plurality of objects included in the acquired image of the surrounding located in front of the vehicle in in a step S120. Based on points data of the target object based on an object type as pre-stored, the navigation device may assign points to each of the plurality of objects, and may determine a target object from among the plurality of objects based on the points of each object. The target object may be an object that it is easy for the driver to recognize. A specific method for determining the target object is described with reference to FIG. 5 and FIG. 6.

Thereafter, the navigation device may determine a movement direction in which the driver can drive along the driving route at the location of the target object in a step S130. According to one embodiment, the navigation device may determine the coordinates on the map where the target object is located, and then determine a turn angle at which the driver can drive along the driving route at the determined coordinates as the movement direction. For example, when the driving route is located on the right around the position of the target object, the movement direction may be determined as a right turn. In another example, when the driving route is located on the left around the position of the target object, the movement direction may be determined as a left turn. In still another example, when the driving route is located at a specific azimuth around the position of the target object, the movement direction may be determined as a turn direction corresponding to the specific azimuth.

Then, the navigation device may output the navigation information including the determined target object and movement direction in a step S140. For example, the navigation device may output the navigation information indicating that the vehicle should be driven in the movement direction around the position of the target object. For example, when the target object is a specific signboard and the movement direction is a right turn, the navigation information indicating a right turn at the specific signboard located ahead of the vehicle may be output.

According to one embodiment, the navigation device may identify the coordinates of the target object, and may output a graphic element related to the target object on the navigation screen at a location related to the identified coordinates. For example, when the target object is a traffic light, a graphic element representing a traffic light may be displayed at a location where the traffic light is located.

According to this embodiment, the target object acting as the terrain feature may be determined, and navigation information related to the target object may be provided to the driver, so that the user may drive intuitively and conveniently the vehicle along the driving route.

FIG. 4 is a flowchart for illustrating operation in the S110 of FIG. 3 in more detail according to one embodiment of the present disclosure. FIG. 4 discloses a method for acquiring an image of a surrounding located ahead of a vehicle when a precise navigation event has occurred. In FIG. 4, it is illustrated that the precise navigation event has occurred when a remaining distance to a turning point is smaller than or equal to a threshold distance.

Referring to FIG. 4, the navigation device may output a driving route received from the route information providing server in a step S111. In this regard, the driving route may be one of the shortest route, the smallest time route, etc.

Next, the navigation device may output the driving route and measure the position of the vehicle periodically or in real time using the GNSS receiver while performing the navigation service in a step S112.

Next, the navigation device may identify a turning point based on the map data and the driving route, and may calculate a remaining distance to the turning point based on the measured vehicle position and the identified turning point in a step S113.

Thereafter, the navigation device may determine whether the calculated remaining distance is smaller than or equal to a predetermined threshold distance in a step S114. Next, when the calculated remaining distance is smaller than or equal to the threshold distance, the navigation device may acquire the image of the surrounding located in front of the vehicle using the sensing device to perform precise navigation using the terrain feature in a step S115.

As described above, when the remaining distance to the turning point (e.g., a right turn point, a left turn point, a U-turn point, etc.) is smaller than or equal to the threshold distance, the navigation device may acquire the image of the surrounding located in front of the vehicle.

In some embodiments, the precise navigation event may occur when the remaining time until reaching the turning point is smaller than or equal to a threshold time. Specifically, the navigation device may measure the position and speed of the vehicle based on coordinates per unit time as measured using the GNSS receiver. Next, the navigation device may calculate the remaining time until reaching the turning point based on the driving route, and the measured vehicle position and speed. Then, when the calculated remaining time is smaller than or equal to the predetermined threshold time, the navigation device may determine that the precise navigation event has occurred and may acquire the image of the surrounding located in front of the vehicle using the sensing device.

FIG. 5 is a flowchart for illustrating operation in the step S120 of FIG. 3 in more detail according to an embodiment of the present disclosure.

FIG. 6 is a diagram for illustrating points data of each object based on a type thereof according to an embodiment of the present disclosure.

Referring to FIG. 5 and FIG. 6, the navigation device may recognize a plurality of objects included in an image of a surrounding located in front of the vehicle using image recognition technology in a step S121. According to one embodiment, the navigation device may recognize a plurality of objects related to a predetermined terrain feature type from the image of the surrounding located in front of the vehicle. In this regard, image data related to types of a plurality of terrain feature objects may be pre-stored in the navigation device and/or the route information providing server. The image data may include characteristics (e.g., shape, pixel value, etc.) of each object type. For example, first image data related to a first object type and second image data related to a second object type may be included in the navigation device and/or the route information providing server. In this case, the navigation device may recognize an object that matches the first image data at a matching percentage equal to or higher than a threshold value as an object related to the first object type, and may recognize an object that matches the second image data at a matching percentage equal to or higher than a threshold value as an object related to the second object type.

Then, the navigation device may identify a specific time range including a current time among the plurality of time ranges in a step S122. As illustrated in FIG. 6, the predetermined plurality of time ranges may include a first time range related to the daytime and a second time range related to the nighttime.

Thereafter, the navigation device may determine points of each of the recognized plurality of objects with reference to specific points data related to the identified specific time range, among the plurality of points data in a step S123. For example, when the current time is included in the first time range related to the daytime, the navigation device may determine points of each recognized object with reference to the points data based on each object type related to the daytime. In this regard, the navigation device may identify how many points is assigned to the type of the recognized object with reference to the points data, and thus may determine the points of the recognized object based on the assignment.

As illustrated in FIG. 6, a plurality of points data may be stored. In other words, the points may be assigned to each object type and the assignment may be recorded in the points data. In this regard, the object may be a terrain feature. Furthermore, as the driver more easily recognizes the object, the higher points may be assigned to the object.

The points of the object may vary depending on a time range. Furthermore, the points of the object may vary depending on a type of the points data. In FIG. 6, it is illustrated that first points data for recognition points and second points data for guidance points are included in the points data. In this case, the points of a specific object included in the first points data and the points of the specific object included in the second points data may be different from each other.

When the first points data and the second points data are used, the first points and the second points may be assigned to one object. For example, using the first points data, a first points for recognition may be assigned to each object. Using the second points data, second points for guidance may be assigned to each object. Then, a first weight may be applied to the first points and a second weight may be applied to the second points, and then the first points and the second points to which the weights have been applied, respectively, may be summed with each other. Thus, the points of each object may be determined based on the sum.

Next, the navigation device may determine the target object among the plurality of objects based on the points of each of the plurality of objects in a step S124. For example, the object with the highest points may be determined as the target object. In this regard, the object with the highest points may be understood as the terrain feature that it is easiest for the driver to recognize or the most suitable terrain feature for performing the navigation.

According to some embodiments, the navigation device may perform object filtering so that only objects whose first points are greater than a threshold value remain, and may determine the target object based on the second points assigned to each of the filtered remaining objects. In this case, among the objects whose first points are greater than or equal to the threshold value, an object with the highest second points may be selected as the target object.

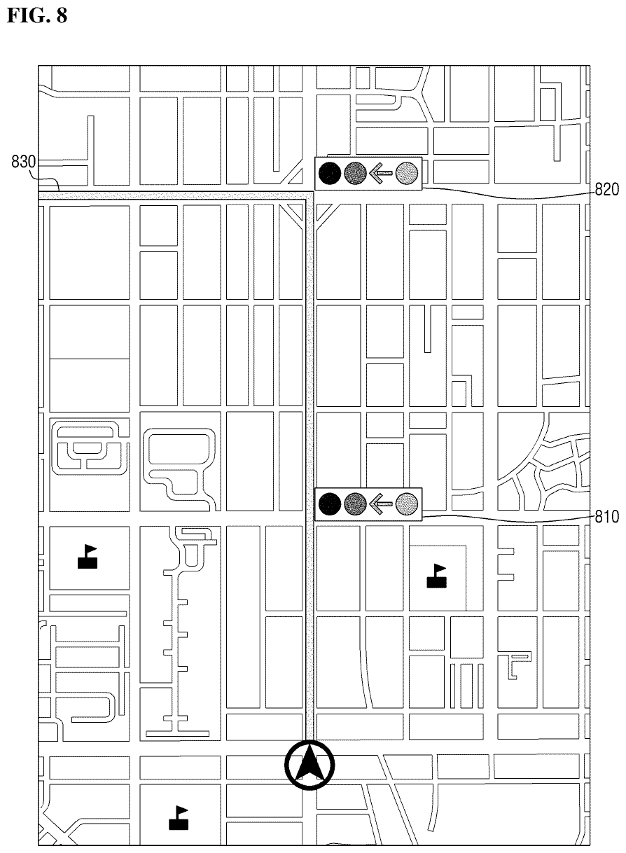

With reference to FIGS. 3 to 6, a navigation method based on a terrain feature is described. Hereinafter, with reference to FIGS. 7 and 8, various examples of the navigation information based on the terrain feature are described.

FIG. 7 is a diagram showing an example of navigation information according to an embodiment of the present disclosure.

In FIG. 7, a target object 710 is determined as a traffic sign related to a stop. Furthermore, a driving route 720 that turns right at the target object 710 may be displayed on the navigation screen. In this case, navigation information that guides the driver to perform a right turn at the target object 710 may be output. For example, navigation information such as “Turn right at the stop sign ahead” may be output.

In one example, an auxiliary object may be determined from the plurality of objects recognized from the image of the surrounding located in front of the vehicle. In other words, the navigation device may determine at least one auxiliary object from the recognized plurality of objects, and may perform navigation using the auxiliary object. In this regard, the auxiliary object may be an object which is located between the target object and the vehicle and which the vehicle passes by while moving to the target object. According to one embodiment, the navigation device may determine an object whose distance to the target object is within a predetermined distance range and whose points exceed a threshold as the auxiliary object. In this case, the navigation device may output the navigation information to guide the driver to pass by the auxiliary object and then move in a movement direction at the target object.

FIG. 8 is a diagram showing another example of navigation information according to one embodiment of the present disclosure.

In FIG. 8, an auxiliary object 810 is a first traffic light, and the target object 820 is a second traffic light. Furthermore, a driving route 830 that turns left at the target object 820 is displayed on the navigation screen.

When the auxiliary object 810 has been determined, the navigation device may output navigation information to guide the driver to pass by the first traffic light in front of the vehicle as the auxiliary object and turn left at the second traffic light. For example, navigation information such as “Pass by a first traffic light at an intersection in front of the vehicle, and then turn left at the second traffic light” may be output.

In one example, a lot of time may be spent in analyzing the surrounding image located in front of the vehicle in the navigation device. Accordingly, according to another embodiment of the present disclosure, the image of the surrounding located in front of the vehicle may be transmitted to the route information providing server, and the route information providing server may determine the target object from among the plurality of objects recognized from the image of the surrounding located in front of the vehicle. In addition, the route information providing server may include a larger number of computing resources than the navigation device. Thus, when the image of the surrounding located in front of the vehicle is analyzed by the route information providing server and the target object is determined based on the analysis result, a computation time may be shortened.

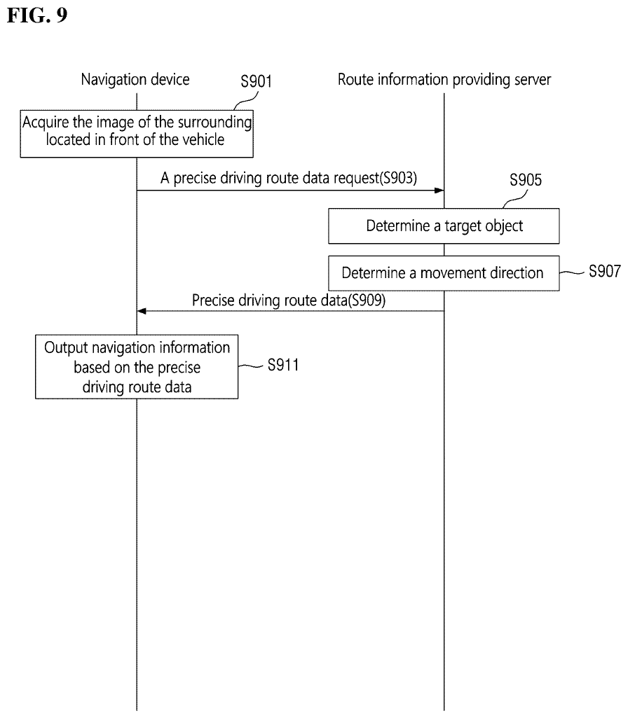

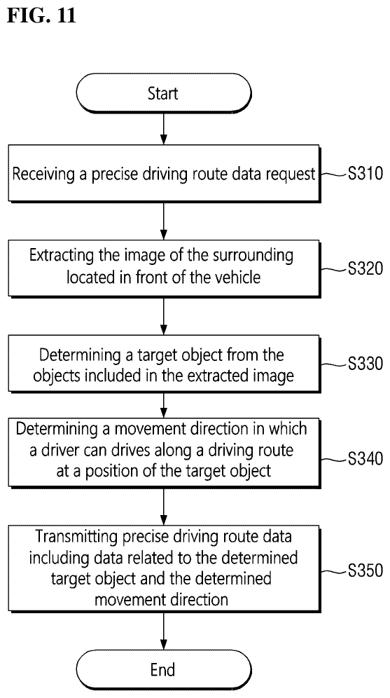

Referring to FIGS. 9 and 11, a method is described in which the navigation device acquires the image of the surrounding located in front of the vehicle and transmits the image to the route information providing server, and then, the route information providing server analyzes the image of the surrounding located in front of the vehicle to determine the target object.

FIG. 9 is a signal processing diagram for performing a navigation method based on a terrain feature according to another embodiment of the present disclosure.

Referring to FIG. 9, when the precise navigation-related event has occurred, the navigation device may acquire the image of the surrounding located in front of the vehicle using the sensing device in a step S901. Then, the navigation device may transmit a precise driving route data request including the image of the surrounding located in front of the vehicle to the route information providing server in a step S903.

Next, the route information providing server may extract the image of the surrounding located in front of the vehicle included in the precise driving route data request, and may determine the target object from among the plurality of objects recognized from the image of the surrounding located in front of the vehicle in a step S905. Next, the route information providing server may determine a movement direction in which the driver can drive along the driving route at the location of the target object in a step S907. Thereafter, the route information providing server may transmit the precise driving route data including the data related to the determined target object and the movement direction to the navigation device in a step S909.

The navigation device may output navigation information based on the received precise driving route data in a step S911. In this regard, the navigation device may output navigation information for guiding the driver to drive in the movement direction at the target object, based on the target object-related data and the movement direction included in the precise driving route data.

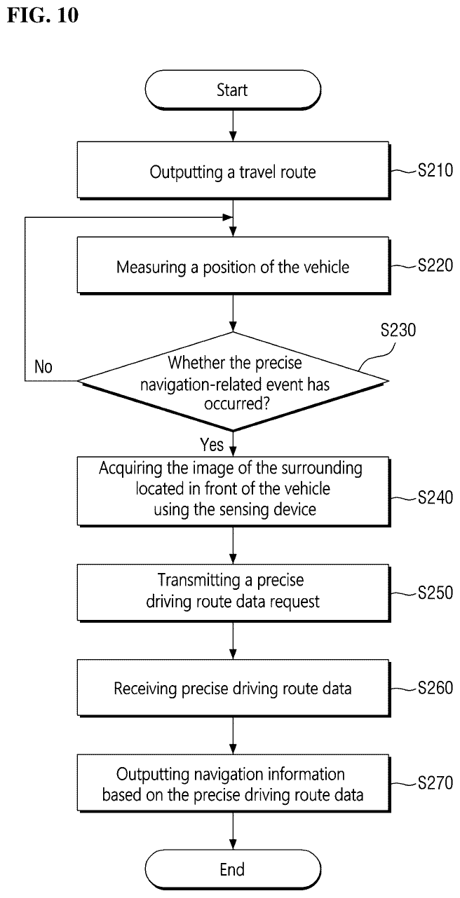

FIG. 10 is a flowchart illustrating a method for performing navigation based on a terrain feature according to still another embodiment of the present disclosure. The method illustrated in FIG. 10 is only an embodiment for achieving the purpose of the present disclosure, and it is obvious that some operations may be added or deleted as needed. Furthermore, the method illustrated in FIG. 10 may be performed by at least one processor (e.g., the processor illustrated in FIG. 12) included in the computing system. The method illustrated in FIG. 10 is described under assuming that the method is performed by the navigation device illustrated in FIG. 1.

Referring to FIG. 10, the navigation device may output a driving route received from an external device in a step S210. In this regard, the external device may be the route information providing server as illustrated in FIG. 2.

Subsequently, the navigation device may measure the vehicle location in real time or periodically while outputting the driving route to perform the navigation service, and update the currently displayed map image in a step S220.

Furthermore, the navigation device may determine whether the precise navigation-related event has occurred based on the measured vehicle location in a step S230. According to one embodiment, the navigation device measures the vehicle location, and may calculate the remaining distance to the turning point based on the driving route and the measured vehicle location. In this case, when the calculated remaining distance is smaller than or equal to the predetermined threshold distance, the navigation device may determine that the precise navigation-related event has occurred.

According to some embodiments, the navigation device may measure the position and the speed of the vehicle, and may calculate the remaining time until reaching the turning point based on the driving route and the measured position of the vehicle. In this case, the navigation device may determine that the precise navigation-related event has occurred when the calculated remaining time is smaller than or equal to a predetermined threshold time.

Thereafter, when the navigation device has determined that the precise navigation-related event has occurred, the navigation device may acquire the image of the surrounding located in front of the vehicle using the sensing device in a step S240. Subsequently, the navigation device may transmit the precise driving route data request including the acquired image of the surrounding located in front of the vehicle to the external device in a step S250.

Next, the navigation device may receive the precise driving route data generated based on the image of the surrounding located in front of the vehicle from the external device in response to the request in a step S260. The precise driving route data may include the target object-related data and the movement direction. Furthermore, the target object-related data may include the target object identifier and the coordinates where the target object is located.

Subsequently, the navigation device may output navigation information for guiding the driver to drive in the movement direction at the object as the terrain feature based on the received precise driving route data in a step S270.

According to some embodiments, the precise driving route data may include the auxiliary object. In this case, the navigation device may output navigation information for guiding the driver to pass by the auxiliary object and to drive in the movement direction at the target object.

FIG. 11 is a flow chart illustrating a method for performing navigation based on a terrain feature according to still yet another embodiment of the present disclosure. The method illustrated in FIG. 11 is only an embodiment for achieving the purpose of the present disclosure, and some operations may be added or deleted as needed. Furthermore, the method illustrated in FIG. 11 may be performed by at least one processor (e.g., the processor illustrated in FIG. 12) included in the computing system. The method illustrated in FIG. 11 is described under assumption that the method is performed by the route information providing server illustrated in FIG. 2.

Referring to FIG. 11, the route information providing server may receive the precise driving route data request including the image of the surrounding located in front of the vehicle from a communication terminal in a step S310. In this regard, the communication terminal may be a navigation device of FIG. 1 or a mobile terminal.

Subsequently, the route information providing server may extract the image of the surrounding located in front of the vehicle as included in the precise driving route data request in a step S320.

Next, the route information providing server may recognize the plurality of objects from the image of the surrounding located in front of the extracted vehicle, and may determine the target object from the recognized plurality of objects in a step S330. According to one embodiment, the route information providing server may recognize the plurality of objects included in the image of the surrounding located in front of the vehicle, and may determine points of each of the plurality of objects based on the type of each of the recognized plurality of objects. Furthermore, the route information providing server may determine the target object from the plurality of objects based on the determined points of each of the plurality of objects. In a similar manner to the method performed by the navigation device as described above, the route information providing server may determine the points of each of the plurality of objects with reference to at least one point data. Additionally, the route information providing server may determine coordinates on the map where the target object is located.

Thereafter, the route information providing server may determine the movement direction in which the vehicle can move along the driving route at the location of the target object in a step S340. According to one embodiment, the route information providing server may determine a turn angle at which the driver can drive the vehicle along the driving route at the coordinates on the map where the target object is located as the movement direction.

Next, the route information providing server may transmit the precise driving route data including the data related to the determined target object and the determined movement direction to the communication terminal in a step S350. In this regard, the data related to the target object may include the identifier of the target object and the coordinates of the target object.

In one example, the route information providing server may determine at least one auxiliary object among the plurality of objects recognized from the image of the surrounding located in front of the vehicle, and may further include the determined auxiliary object into the precise driving route data. According to one embodiment, the route information providing server may determine an object whose distance to the target object is within a predetermined distance range and whose points exceed a threshold as the auxiliary object.

FIG. 12 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

A computing system 1000 of FIG. 12 may be an example of a hardware structure of one or more computing apparatus. For example, the computing system 1000 of FIG. 12 may be an example of the hardware structure of at least one of the navigation device, and the route information providing server.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may include instructions for: acquiring an image of a surrounding located in front of a vehicle using a sensing device; determining a target object acting as a terrain feature among a plurality of objects included in the acquired image of the surrounding located in front of the vehicle; determining a movement direction in which a driver drives along a driving route at a position of the target object; and outputting navigation information including the determined target object and movement direction.

According to another embodiment, the computer program 1500 may include instructions for: acquiring an image of a surrounding located in front of a vehicle using a sensing device, transmitting the image of the surrounding located in front of the vehicle to an external device; receiving precise driving route data generated based on the image of the surrounding located in front of the vehicle from the external device; and outputting navigation information for guiding a driver to drive in a movement direction at an object acting as a terrain feature, based on the precise driving route data. A communication interface 1200 may be used to transmit the image of the surrounding located in front of the vehicle to the external device. Furthermore, the communication interface 1200 may be used to receive the precise driving route data from the external device.

According to another embodiment, the computer program 1500 may include instructions for: receiving an image of a surrounding located in front of the vehicle from a communication terminal; determining a target object acting as a terrain feature from among a plurality of objects included in the received image of the surrounding located in front of the vehicle; determining a movement direction in which the driver can drive along a driving route at a location of the target object; and transmitting precise driving route data including data related to the determined target object and the determined movement direction to the communication terminal. The communication interface 1200 may be used to receive the image of the surrounding located in front of the vehicle from the communication terminal. Furthermore, the communication interface 1200 may be used to transmit the precise driving route data to the communication terminal.

In some embodiments, the computing system 1000 as described with reference to FIG. 12 may be configured using one or more physical servers included in a server farm based on cloud technology such as virtual machines. In this case, at least some of the components as illustrated in FIG. 12, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 12. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs should be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A navigation method performed by a computing system, the method comprising:
acquiring an image of a surrounding located in front of a vehicle using a sensing device;
determining a target object acting as a terrain feature among a plurality of objects included in the acquired image of the surrounding located in front of the vehicle;
determining a movement direction in which a driver drives along a driving route at a position of the target object; and
outputting navigation information including the determined target object and movement direction.

2. The navigation method of claim 1, wherein acquiring the image of the surrounding located in front of the vehicle includes:
measuring a position of the vehicle;
calculating a residual distance to a turning point based on the driving route and the measured position of the vehicle; and
when the calculated residual distance is smaller than or equal to a predetermined threshold distance, acquiring the image of the surrounding located in front of the vehicle using the sensing device.

3. The navigation method of claim 1, wherein acquiring the image of the surrounding located in front of the vehicle includes:
measuring a position and a speed of the vehicle;
calculating a remaining time until reaching a turning point based on the driving route, the measured position and speed of the vehicle; and
when the calculated remaining time is smaller than or equal to a predetermined threshold time, acquiring the image of the surrounding located in front of the vehicle using the sensing device.

4. The navigation method of claim 1, wherein determining the target object includes:
recognizing the plurality of objects included in the image of the surrounding located in front of the vehicle;
determining of points of each of the recognized plurality of objects based on a type of each of the recognized plurality of objects; and
determining the target object among the plurality of objects, based on the determined points of each of the plurality of objects.

5. The navigation method of claim 4, wherein determining the points of each of the plurality of objects includes:
identifying a specific time range including a current time among a predetermined plurality of time ranges; and
determining the points of each of the plurality of objects, based on object type-specific points data related to the identified specific time range.

6. The navigation method of claim 4, wherein determining the points of each of the plurality of objects includes:
assigning first points to each of the plurality of objects with reference to first points data in which points of each object type are recorded;
assigning second points to each of the plurality of objects with reference to second points data in which points of each object type are recorded, wherein the second points data are different from the first points data; and
determining the points of each of the plurality of objects, based on the first points and the second points assigned to each of the plurality of objects.

7. The navigation method of claim 6, wherein determining the points of each of the plurality of objects includes:
applying a first weight to the first points;
applying a second weight to the second points;
summing the first points to which the first weight has been applied and the second points to which the second weight has been applied; and
determining the points of each object based on the summing result.

8. The navigation method of claim 1, wherein determining the target object includes determining coordinates on a map where the target object is located,
wherein determining the movement direction includes determining a turn angle at which the driver can drive along the driving route at the determined coordinates as the movement direction.

9. The navigation method of claim 1, wherein determining the target object includes determining an auxiliary object located between the target object and the vehicle, from among the plurality of objects included in the acquired image of the surrounding located in front of the vehicle,
wherein the navigation information further includes the auxiliary object,
wherein the navigation information guides the driver to pass by the auxiliary object, and then, drive in the movement direction at the target object.

10. A navigation method performed by a computing system, the method comprising:
acquiring an image of a surrounding located in front of a vehicle using a sensing device;
transmitting the image of the surrounding located in front of the vehicle to an external device;
receiving precise driving route data generated based on the image of the surrounding located in front of the vehicle from the external device; and
outputting navigation information for guiding a driver to drive in a movement direction at an object acting as a terrain feature, based on the precise driving route data.

11. The navigation method of claim 10, wherein acquiring the image of the surrounding located in front of the vehicle using the sensing device includes:
determining whether a precise navigation-related event has occurred; and
upon determination that the precise navigation related event has occurred, acquiring the image of the surrounding located in front of the vehicle using the sensing device.

12. The navigation method of claim 11, wherein determining whether the precise navigation-related event has occurred includes:
measuring a position of the vehicle;
calculating a remaining distance to a turning point, based on the driving route and the measured position of the vehicle; and
when the calculated remaining distance is smaller than or equal to a predetermined threshold distance, determining that the precise navigation-related event has occurred.

13. The navigation method of claim 11, wherein determining whether the precise navigation-related event has occurred includes:
measuring a position and a speed of the vehicle;
calculating a remaining time until reaching a turning point, based on the driving route, the measured position and speed of the vehicle; and
when the calculated remaining time is smaller than or equal to a predetermined threshold time, determining that the precise navigation-related event has occurred.

14. The navigation method of claim 10, wherein acquiring the image of the surrounding located in front of the vehicle includes:
measuring a position of the vehicle;
calculating a remaining distance to a turning point, based on the driving route of the vehicle and the measured position of the vehicle; and
when the calculated remaining distance is smaller than or equal to a predetermined threshold distance, acquiring the image of the surrounding located in front of the vehicle, using the sensing device.

15. The navigation method of claim 10, wherein acquiring the image of the surrounding located in front of the vehicle includes:
measuring a position and a speed of the vehicle;
calculating a remaining time until reaching a turning point, based on the driving route of the vehicle and the measured position and speed of the vehicle; and
when the calculated remaining time is smaller than or equal to a predetermined threshold time, acquiring the image of the surrounding located in front of the vehicle, using the sensing device.

16. A system comprising:
one or more processors; and
a memory configured to store a computer program executed by the one or more processors,
wherein the computer program comprises instructions for performing operations comprising:
receiving an image of a surrounding located in front of a vehicle from a communication terminal;
determining a target object acting as a terrain feature from among a plurality of objects included in the received image of the surrounding located in front of the vehicle;
determining a movement direction in which a driver can drive along a driving route at a location of the target object; and
transmitting precise driving route data including data related to the determined target object and the determined movement direction to the communication terminal.

17. The system of claim 16, wherein determining the target object includes:
recognizing the plurality of objects included in the image of the surrounding located in front of the vehicle;
determining points of each of the plurality of objects based on a type of each of the recognized plurality of objects; and
determining the target object from among the plurality of objects, based on the determined points of each of the plurality of objects.

18. The system of claim 17, wherein determining the points of each of the plurality of objects includes:
identifying a specific time range including a current time among a predetermined plurality of time ranges; and
determining points of each of the plurality of objects, based on object type-specific points data related to the identified specific time range.

19. The system of claim 17, wherein determining the points of each of the plurality of objects includes:
assigning first points to each of the plurality of objects with reference to first points data in which points of each object type are recorded;
assigning second points to each of the plurality of objects with reference to second points data in which points of each object type are recorded, wherein the second points data are different from the first points data; and
determining the points of each of the plurality of objects, based on the first points and the second points assigned to each of the plurality of objects.

20. The system of claim 16, wherein determining the target object includes determining coordinates on a map where the target object is located,
wherein determining the movement direction includes determining a turn angle at which the driver can drive along the driving route at the determined coordinates as the movement direction.
